(19) United States
(12) Patent Application Publication
(10) Pub. No.: US 2011/0073323 A1
(43) Pub. Date: Mar. 31, 2011

(54) LINE RETENTION ARRANGEMENT AND METHOD

(75) Inventor: Martin P. Coronado, Cypress, TX (US)

(73) Assignee: BAKER HUGHES INCORPORATED, Houston, TX (US)

(21) Appl. No.: 12/569,512

(22) Filed: Sep. 29, 2009

(51) Int. Cl. E21B 41/00; F16L 3/00; E21B 17/00; E21B 19/00

(52) U.S. Cl. 166/380; 248/65; 166/65.1

(57) ABSTRACT

A line retention arrangement including one or more supports; and two or more clips, each clip having a base and a cantilever portion the two or more clips being oriented oppositely to one another, each clip mounted to the one or more supports. A method for retaining one or more lines at a string.

### BACKGROUND

In the downhole drilling and completion industry, numerous lines are needed to facilitate various operations in the downhole environment. Such lines include control lines, power lines, sensory lines, communication lines, etc. Routing such lines is always a concern in that they must be protected to varying degrees, must be fixed to varying degrees, etc. Since real estate is very limited for everything that must be done in the downhole environment the above noted considerations regarding lines is a complex question. In some cases the lines will be run within joints of a string whereby they are generally required to include connection that can withstand downhole conditions. In other cases, lines are run through screens where flow cutting considerations and flow area under the screens must be fielded. In other arrangements the lines are run in segments along the outside diameter of a string and covered in some way. Often such arrangements require connections and also slow the run in process as the lines are connected to the string as the string is run into the hole.

Line use in the downhole industry is not likely to abate in the foreseeable future and new means and methods for addressing the various issues they present are always welcomed by the art.

### SUMMARY

A line retention arrangement including one or more supports; and two or more clips, each clip having a base and a cantilever portion the two or more clips being oriented oppositely to one another, each clip mounted to the one or more supports.

A line retention arrangement including a plurality of clips disposed along a string, the clips being spaced from one another by a distance related to a rigidity of a line to be retained thereby, the relation being dictated by the ability to bend the line sufficiently to clear a cantilever portion of a clip adjacent to a clip in which the line is already retained.

A method for retaining one or more lines at a string including bending the one or more lines in one direction to clear a tip of a cantilever portion of a clip extending in a first direction; urging the one or more lines under the cantilever portion of the clip; bending the line in an opposite direction to clear a tip of a next adjacent cantilever portion; and urging the one or more lines under the next adjacent cantilever portion.

### BRIEF DESCRIPTION OF THE DRAWINGS

Referring now to the drawings wherein like elements are numbered alike in the several Figures:

FIG. 1 is a perspective view of a portion of a string having a line retention arrangement disposed thereon; and

FIG. 2 is an elevation view of a clip of the arrangement.

### DETAILED DESCRIPTION

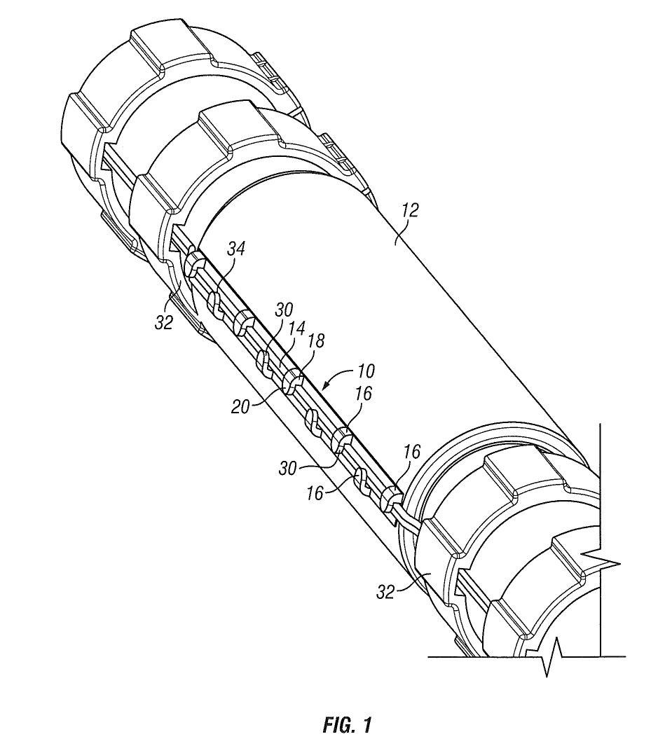

Referring to FIG. 1, a line retention arrangement 10 is illustrated on a portion of a string 12. One or more lines 14 are illustrated engaged with the arrangement 10. In the illustrated embodiment the arrangement comprises a number of clips 16 in opposed orientation, one relative to the next. It will be appreciated that in the illustrated embodiment each clip 16 extends laterally enough to overlap the position of the adjacent clip 16. While such is illustrated, it is to be appreciated that in other embodiments the reach of the cantilever portion does not necessarily have to be sufficient to overlap the next clip but could be shorter. This is related to the type of line that is to be retained in the arrangement. For example if the line has an aspect ratio of greater than one, only the lateral edges of the line need be captured by the cantilever portion 20. It will be understood that the longer the overlap the greater the retaining power of the arrangement but the greater the effort required during installation of a line 14.

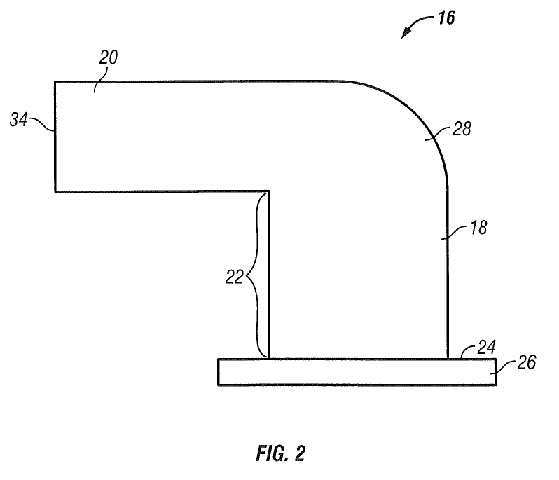

Referring to FIG. 2, each clip 16 comprises a base 18 and a cantilever portion 20. The base 18 is, in each embodiment, to support the cantilever portion 20 at a radial distance 22 from a mounting surface 24 of a clip support 26. The radial distance 22 for individual embodiments is related to a thickness of a line 14 to be retained thereby. The clip 16 in some embodiments also employs a radiused corner 28 and radiused end 30 in order to reduce the likelihood of impact, getting stuck and damaging other downhole components when running. Other edges of the clips 16 can also be radiused for the same reason.

The base 18 of at least the clips 16 on one lateral side of the arrangement 10 are mounted to the support 26. Mounting may be effected by welding or any other affixation method suitable for the environment and materials used. As illustrated, the support is attached to only one side of an arrangement 10. Another support 26 with another set of oppositely facing clips 16 would be positioned adjacent the support 26 to form the arrangement 10. Alternatively the support 26 can be wide enough to allow for sets of clips 16 oriented in both directions to be placed thereon. FIG. 1 is illustrative of both constructions because the lines 14 cover either a single support 26 or cover a gap between a pair of supports 26.

An advantage of the arrangement 10 where two supports 26 are employed instead of one is that they can be placed upon the string at whatever lateral displacement is needed for the line 14 to be retained. The single support 26 does not allow such adjustability. Moreover, because a two piece support 26 arrangement leaves a gap between the supports a thick line 14 can be retained or the clips can have a smaller radial dimension 22 to fit the same line 14 because the line will rest on the string rather than on the support 26. The thickness of the support then will be the difference between the two arrangements.

The arrangement 10 is affixed to a string by welding or any other suitable affixation and substantially spans distances between other protective structures. The number of clips between other protective structures may be 2 or more, with an upper limit being set by practicality with respect to the ability to install the line 14. More specifically, if the clips 16 are too close together, it becomes impossible to out line 14 through them from a laterally adjacent position, which will be the operation necessary in a downhole run environment. Further the number of clips 16 is related to the stiffness of the line 14 in bending. This will be more clearly understood hereunder.

In a downhole system that employs the arrangement 10 as hereinbefore described, the arrangement 10 will be extant or placed upon a string being readied for a run. A line 14, exiting another protective feature, such as collar 32, is bent in one direction a sufficient amount to clear a tip 34 of a cantilever portion 20 of one clip 16 allowing the line 14 to be slipped underneath the cantilever portion 20 and then bent back the other way until it will clear the tip 34 of the next adjacent cantilever portion 20 whereby it will be slipped under that cantilever portion. In one embodiment the bending is elastic. The method of movement of the line 14 will continue until the line 14 is under all of the cantilever portions 20 of a particular system. In view of the method for installation of the line 14 it will be clearer to the reader why the proximity of clips would vary in different situations. With a line 14 that is very flexible, more clips spaced more closely together is not only possible but needed to ensure that the line stays in place. Where a line 14 is stiffer, clips 16 will need to be farther apart since bending the line 14 back and forth will be more difficult. In addition, not as many clips would be needed in this event as the line 14 will not easily be urged out of the retained position by contact with another structure due to its own rigidity. The inventor hereof, has determined that a single clip 16 can work if the line 14 is very rigid and the distance between the adjacent other protectors 32 is not great enough to allow for deflection of the line 14. In one embodiment, two clips in opposing directions or three clips in opposing directions will provide greater support even for a stiff line 14. While the greater the number of clips used the greater the retention capability, the cost of the arrangement is also increased proportionally to the number of clips used. Accordingly, it is desirable to reduce the number of clips to that number whereby line 14 rigidity will resist deflection to less than the deflection required to dislodge the line 14 from the arrangement 10.

A significant benefit of the arrangement disclosed herein is that it facilitates running lines without connections. Connections increase cost, reduce efficiency and sometimes reduce reliability. None of these properties are attributes.

While one or more embodiments have been shown and described, modifications and substitutions may be made thereto without departing from the spirit and scope of the invention. Accordingly, it is to be understood that the present invention has been described by way of illustrations and not limitation.

1. A line retention arrangement comprising:
one or more supports; and
two or more clips, each clip having a base and a cantilever portion the two or more clips being oriented oppositely to one another, each clip mounted to the one or more supports.

2. A line retention arrangement as claimed in claim 1 wherein one or more of the two or more clips includes a radiused corner.

3. A line retention arrangement as claimed in claim 1 wherein the arrangement employs one support.

4. A line retention arrangement as claimed in claim 1 wherein the arrangement employs two supports laterally spaceable from one another.

5. A line retention arrangement as claimed in claim 1 wherein a dimension of each clip between the one or more supports and the cantilever portion approximates a dimension of a line to be retained thereby.

6. A line retention arrangement in combination with a string comprising:
the arrangement as claimed in claim 1 affixed to the string.

7. A line retention arrangement as claimed in claim 1 wherein the cantilever portions of the two or more clips oriented oppositely to one another extend beyond a centerline between the two or more clips.

8. A line retention arrangement as claimed in claim 1 wherein the cantilever portions of the two or more clips oriented oppositely to one another fall short of a centerline between the two or more clips.

9. A line retention arrangement comprising:
a plurality of clips disposed along a string, the clips being spaced from one another by a distance related to a rigidity of a line to be retained thereby, the relation being dictated by the ability to bend the line sufficiently to clear a cantilever portion of a clip adjacent to a clip in which the line is already retained.

10. A line retention arrangement as claimed in claim 9 wherein the arrangement provides retention in both lateral directions.

11. A line retention arrangement as claimed in claim 10 wherein the arrangement provides retention radially.

12. A method for retaining one or more lines at a string comprising:
bending the one or more lines in one direction to clear a tip of a cantilever portion of a clip extending in a first direction;
urging the one or more lines under the cantilever portion of the clip;
bending the line in an opposite direction to clear a tip of a next adjacent cantilever portion; and
urging the one or more lines under the next adjacent cantilever portion.

13. A method as claimed in claim 12 wherein the urging is in one direction with respect to the cantilever portion and in the opposite direction with respect to the next adjacent cantilever portion.

14. A method as claimed in claim 12 wherein the bending is elastic.
